(19) United States
(12) Patent Application Publication
(10) Pub. No.: US 2010/0027238 A1
(43) Pub. Date: Feb. 4, 2010

(54) Polarization-recovery illumination system with high illumination efficiency

(75) Inventors: Haizhang Li, Orlando, FL (US); Marcial Vidal, Merritt Island, FL (US)

Correspondence Address: RONALD J. MEETIN, ATTORNEY AT LAW, 210 CENTRAL AVENUE, MOUNTAIN VIEW, CA, 94043-4869, US

(73) Assignee: Video Display Corporation

(21) Appl. No.: 12/460,793

(22) Filed: Jul. 23, 2009

Related U.S. Application Data
(60) Provisional application No. 61/137,688, filed on Aug. 1, 2008.

(51) Int. Cl. F21V 9/14

(52) U.S. Cl. 362/19

(57) ABSTRACT

A polarization-recovery illumination system contains a light-source structure (401 or 501/502), a light-pipe structure (420, 503/504/505/506/507/508, or 503/504/505/506/511/512), and a polarization-recovery light integrator (402/403/404/405/406/407/408). The light-pipe structure is configured so that the light distribution across the aperture of the polarization-recovery light integrator is substantially independent of the shape of the light-source area of the light-source structure. This enables the illumination system to have high illumination efficiency. The illumination is also highly uniform.

### CROSS-REFERENCE TO RELATED APPLICATION

This claims priority to U.S. provisional patent application 61/137,688, filed 1 Aug. 2008, the contents of which are incorporated by reference to the extent not repeated herein.

### FIELD OF USE

This invention relates to polarization-recovery illumination systems.

### BACKGROUND ART

Lens array polarization-recovery illumination systems are widely used in display applications. FIG. 1 shows a conventional lens array polarization-recovery illumination system. Unpolarized light emitted from light source 101 is collimated by collimating lens 102 to form a beam of unpolarized collimated light that propagates generally parallel to optical axis 110. The unpolarized collimated light impinges on a polarization-recovery light integrator which largely converts the unpolarized collimated light to linearly polarized light that impinges on light-modulation panel 109 with moderately uniform illumination.

The polarization-recovery light integrator consists of first plano-convex lens array 103, second plano-convex lens array 104, strip-mask plate 105, polarization beam splitter (“PBS”) prism bar plate 106, plate 107 of half-wave retardation strips, and focusing lens 108. Lens arrays 103 and 104 are two-dimensional arrays containing the same number of plano-convex lenslets (individual lenses) arranged in the same plural number of rows and the same plural number of columns. PBS prism bar plate 106 is a one-dimensional array of PBS prism bars. The number of PBS prism bars is the same as the number of rows of lenslets in lens array 103 or 104.

Collimated light beam 102 passes through the lenslets of first lens array 103 to form initial partial light fluxes (or sub-beams) 111i traveling generally parallel to optical axis 110. Each initial partial flux 111i consists of the light which passed through a different one of the lenslets of lens array 103. As viewed along optical axis 110, light fluxes 111i are thus distributed in rows and columns respectively corresponding to the rows and columns of lens array 103. The total number of light fluxes 111i equals the number of lenslets in lens array 103 or 104. Light fluxes 111i pass respectively through the lenslets of second lens array 104 and then respectively through openings in strip-mask plate 105 which blocks extraneous (unwanted) light.

Light fluxes 111i in each light-flux row impinge on a corresponding different one of the PBS prism bars in PBS prism bar plate 106. Each PBS prism bar transmits the p linearly polarized component of each incident light flux 111i to produce p linearly polarized light flux 112i. The s linearly polarized component of each incident light flux 111i goes through two reflections in its PBS prism bar. The s linearly polarized components of light fluxes 111i then pass through the half-wave strips of half-wave strip plate 107 and are respectively converted into p linearly polarized light fluxes 113i. Directly passed p polarized light fluxes 112i and converted p polarized light fluxes 113i propagate in the same direction generally parallel to optical axis 110. Focusing lens 108 focuses p polarized light fluxes 112i and 113i onto panel 109 so that light fluxes 112i and 113i mix across panel 109. This causes the light illumination on panel 109 to be moderately uniform.

FIG. 2 illustrates the light distribution of directly passed light fluxes 112i and converted light fluxes 113i on the exit surface of PBS prism bar plate 106 for the situation in which light source 101 emits light from a generally circular area. Items 201i, indicated in solid-line circles, are light spots produced from directly passed light fluxes 112i as images of light source 101. Items 202i, indicated in dotted-line circles, are light spots produced from converted light fluxes 113i as images of light source 101.

As FIG. 2 shows, there are relatively large spaces between image spots 201i and 202i of light source 101. Only a relatively small part of the aperture (or available light-transmission area) of PBS prism bar plate 106 is used. In the situation of FIG. 2, image spots 201i and 202i occupy considerably less than half of the aperture of PBS prism bar plate 106. Consequently, the illumination efficiency of the lens array polarizing illumination system of FIG. 1 is reduced.

It would be desirable to have a lens array polarization-recovery illumination system that utilizes considerably more, ideally nearly all, of the aperture of the PBS prism bar plate so as to increase the illumination efficiency and cause the illumination to be highly uniform. It would also be desirable to have embodiments which accommodate different numbers of light sources.

### GENERAL DISCLOSURE OF THE INVENTION

The present invention furnishes a polarization-recovery illumination system that provides highly uniform illumination and has high illumination efficiency. The illumination system of the invention contains a light-source structure, a light-pipe structure, and a polarization-recovery light integrator. The light-source structure, formed with one or more light sources, provides light across a light-source area. The light-pipe structure, which contains one or more light pipes, has a light-entrance area and a light-exit area. Light provided from the light-source structure generally across its light-source area enters the light-pipe structure at its light-entrance area, passes largely through the light-pipe structure, and exits the light-pipe structure across largely all of its light-exit area.

The polarization-recovery light integrator performs polarization-recovery light integration by first splitting light which exited the light-pipe structure across its light-exit area into multiple initial partial light fluxes. The polarization-recovery light integrator then converts orthogonally linearly polarized components of the initial light fluxes into multiple partial fluxes of linearly polarized light, i.e., light of substantially only a single linear polarization type. Finally, the polarization-recovery light integrator mixes the fluxes of linearly polarized light so as integrate them.

The polarization-recovery light integrator is characterized by a light-transmission area, referred to as an aperture, through which light can pass in traveling through the integrator. Each flux of linearly polarized light passes through a portion, referred to here as a light spot, of the integrator's aperture. Each light spot is normally largely an image of the light-exit area of the light-pipe structure. By appropriately choosing the shape of the light-exit area of the light-pipe structure, the light spots occupy a very large fraction of the total aperture area. The usage efficiency of the integrator aperture is very high. As a result, the intensity of the mixed fluxes of linearly polarized light is highly uniform and is achieved in a highly efficient manner.

The light-exit area of the light-pipe structure is typically of rectangular shape. The light spots are then of the same rectangular shape and can be packed very close to one another in the integrator aperture. Additionally, the light-pipe structure enables the shape of the light spots to be largely independent of the shape of the light-source area of the light-source structure. The light-source area of the light-source structure can therefore be of a materially different shape than the light-exit area of the light-pipe structure. If, for example, the light-source area is of circular or elliptical shape or of different rectangular shape, i.e., different length-to-width ratio, than a rectangular shape chosen for the exit area of the light-pipe structure, the illumination efficiency of the present illumination system is still very high.

The polarization-recovery light integrator of the present illumination system normally contains a first lens array, a second lens array, a PBS prism bar plate, and a half-wave retardation strip plate. The first lens array splits light which exited the light-pipe structure across its light-exit area into the initial light fluxes. In particular, a selected plurality of the initial light fluxes are so formed. The second lens array images the initial light fluxes on respective locations close to the PBS prism bar plate.

The PBS prism bar plate splits the initial light fluxes into a like plurality of respective primary light fluxes of a first linear polarization type and a like plurality of respective light fluxes of a second linear polarization type opposite to the first linear polarization type. Light of the primary fluxes of the first linear polarization type passes through the PBS prism bar plate.

The PBS prism bar plate directs, typically by double reflection, light of the fluxes of the second linear polarization type to the half-wave retardation strip plate which converts them into a like plurality of respective further light fluxes of the first linear polarization type propagating in generally the same direction as the primary light fluxes of the first polarization type. The primary and further light fluxes of the first polarization type thereby largely form the aforementioned fluxes of linearly polarized light. The polarization-recovery light integrator normally includes a focusing lens that directs the fluxes of linearly polarized light, i.e., the primary and further light fluxes of the first polarization type, toward a target location so that they mix with one another.

The PBS prism bar plate has a light-transmission area, or aperture, through which the primary light fluxes of the first linear polarization type pass through the bar plate's beam-splitting elements and through which the further light fluxes of the second polarization type are directed to the sides of the beam-splitting elements. The aperture of the PBS prism bar plate typically implements the aperture that characterizes the polarization-recovery light integrator. The presence of the light-pipe structure in combination with choosing the shape of its light-exit area in the above described manner enables the light spots of the primary light fluxes of the first linear polarization type and the light spots of the light fluxes of the second linear polarization type to occupy a very large fraction of the bar plate's aperture. Hence, the illumination efficiency is very high. This enables the illumination at the target location to be highly uniform.

The illumination system of the invention preferably includes a collimator for collimating light exiting the light-pipe structure across the light-exit area into a beam of collimated light. The polarization-recovery light integrator then splits collimated light provided from the collimator into the aforementioned initial light fluxes.

When only one light source is present in the light-source structure so that the light-source area is substantially a single continuous area, only one light pipe is typically present in the light-pipe structure. Both the light-entrance and light exit areas of the light pipe are typically rectangular at different length-to-width ratios. Consequently, the light pipe is tapered.

In situations where a plurality of light sources are present in the light-source structure includes, the light-pipe structure typically has an input light-pipe section and an output light-pipe section. The input light-pipe section includes like plurality of input light pipes. Each input light pipe directs light from a different one of the light sources to the output light-pipe section. The output light-pipe section combines light from the input light pipes to produce the light exiting the light-pipe structure. The output light-pipe section typically includes one or more output light pipes and one or more light reflectors which direct light to the output light pipe or pipes.

To summarize, the polarization-recovery illumination system of the invention furnishes highly uniform illumination and high illumination efficiency. The light-pipe structure enables the light distribution across the aperture of the polarization-recovery light integrator to be substantially independent of the shape of the light-source area of the light-source structure. High illumination efficiency can thereby be achieved with various different shapes for the shape of the light-source area of the light-source structure. Consequently, the invention provides a substantial advance over the prior art.

### BRIEF DESCRIPTION OF THE DRAWINGS

FIG. 1 is a diagram of a conventional lens array polarization-recovery illumination system.

FIG. 2 is a cross-sectional view of the distribution of light spots across the aperture of the PBS prism bar plate in the conventional illumination system of FIG. 1.

FIG. 3 is a cross-sectional front view of the highly efficient distribution of light spots across the exit aperture of the PBS prism bar plate in a lens-array polarization-recovery illumination system configured according to the invention.

FIG. 4 is a diagram of a lens array polarization-recovery illumination system configured according to the invention so as to achieve the highly efficient light-spot distribution of FIG. 3 using a single light source.

FIG. 5 is a perspective view of the light pipe in the polarization-recovery illumination system of FIG. 4.

FIG. 6 is a diagram of a lens array polarization-recovery illumination system configured according to the invention so as to achieve the highly efficient light-spot distribution of FIG. 3 using a pair of light sources.

FIG. 7 is a diagram of another lens array polarization-recovery illumination system configured according to the invention so as to achieve a highly efficient light-spot distribution using a pair of light sources.

FIG. 8 is a cross-sectional front view of the highly efficient distribution of light spots across the exit aperture of the PBS prism bar plate in the lens-array polarization-recovery illumination system of FIG. 7.

Like reference symbols are used in the drawings and in the description of the preferred embodiments to represent the same, or very similar, item or items.

### DESCRIPTION OF THE PREFERRED EMBODIMENTS

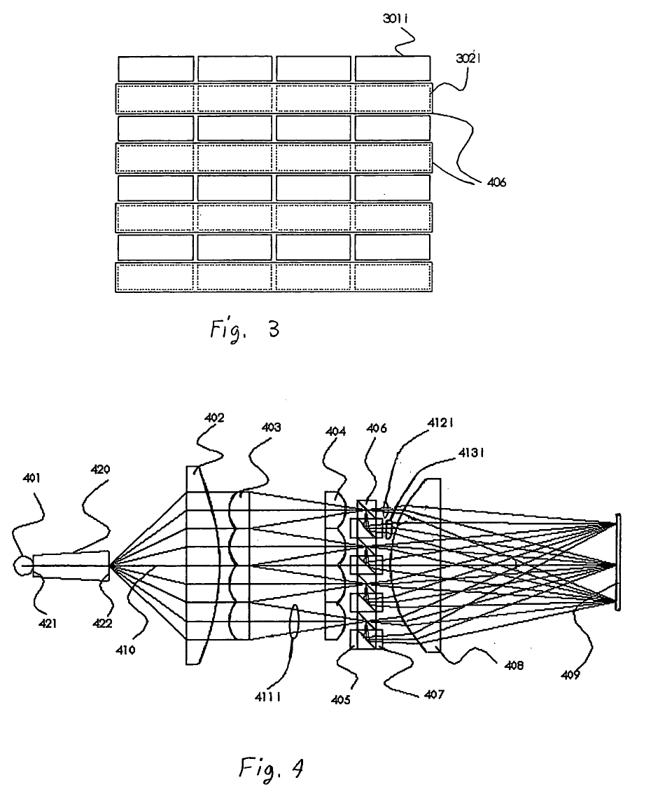

Referring to FIG. 3, it shows an example of a typical distribution of the image light spots across an aperture that characterizes the polarization-recovery light integrator of a polarization-recovery illumination system configured in accordance with the invention so as to achieve high illumination efficiency and to provide linearly polarized light of highly uniform illumination at a target location. The aperture represented in FIG. 3 is at the exit surface of a PBS prism bar plate corresponding to PBS prism bar plate 106 in the conventional polarization-recovery illumination system of FIG. 1.

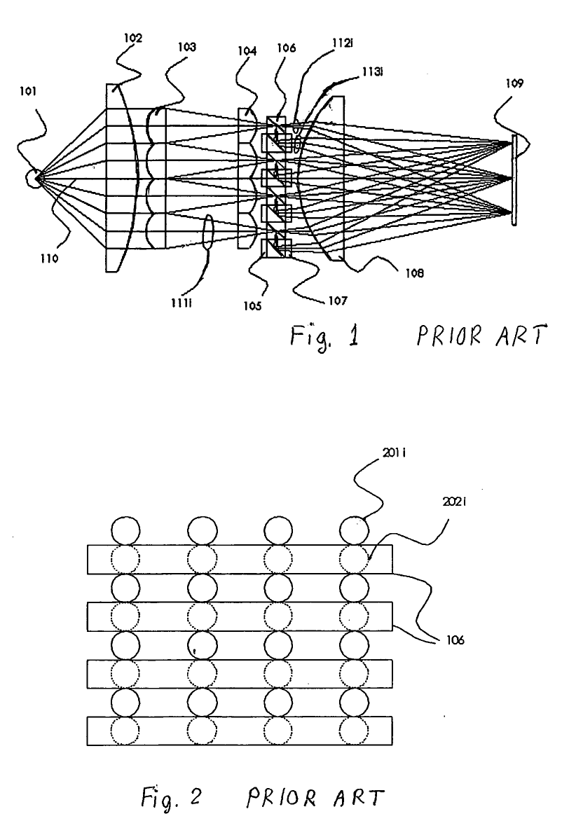

Circular image light spots 201i of directly passed light fluxes 112i and circular image light spots 202i of converted light fluxes 113i in FIG. 2 respectively become rectangular image light spots 301i and 302i in FIG. 3. Images 301i and 302i occupy much more of the aperture area than images 201i and 202i. In contrast to images 201i and 202i which occupy considerably less than half of the aperture of PBS prism bar plate 106 in the prior art situation of FIG. 2, images 301i and 302i occupy most, normally considerably more than half, of the aperture of the PBS prism bar plate in the present polarization-recovery illumination system. Although there are gaps between images 301i and 302i in the example of FIG. 3, the sizes of images 301i and 302i can be increased so that these gaps become virtually zero.

The shape and size of the images 301i and 302i depend on the size and shape of the lenslets in lens arrays corresponding to lens arrays 103 and 104 in the illumination system of FIG. 1. A preferred design is to make the height of images 301i and 302i equal to approximately half of the lenslet height. The total height of each pair of vertically adjacent images 301i and 302i is then approximately the lenslet height.

FIG. 4 illustrates a lens array polarization-recovery illumination system configured in accordance with the invention so as to achieve the highly efficient image light spot distribution of FIG. 3. The illumination system of FIG. 4 consists of (a) a light-source structure formed with a light source 401, (b) a light-pipe structure formed with a light pipe 420, (c) a light collimator formed with a collimating lens 402, and (d) a polarization-recovery light integrator formed with a first plano-convex lens array 403, a second plano-convex lens array 404, a strip-mask plate 405, a PBS prism bar plate 406, a plate 407 of half-wave retardation strips, and a focusing lens 408. A light-modulation panel 409, preferably of rectangular shape, is situated at the target location for the linearly polarized light produced by the illumination system of FIG. 4.

Components 402-408 are configured, arranged, and operable largely the same as components 102-108 in the conventional illumination system of FIG. 1 subject to the different light distribution illustrated in FIG. 3. In particular, the convex sides of the lenslets of first lens array 403 preferably face collimating lens 402. The planar sides of the lenslets of lens array 403 preferably face the planar sides of the lenslets of second lens array 404. The convex sides of the lenslets of lens array 404 then face strip-mask plate 405 and PBS prism bar plate 406. Also, the lenslets of lens arrays 403 and 404 are preferably substantially rectangular in shape so as to match the rectangular shape preferably used for panel 409.

Each of lens arrays 403 and 404 is (analogous to lens arrays 103 and 104) a two-dimensional array of row and columns of plano-convex lenslets. Lens arrays 403 and 404 contain the same plural number of lenslet rows and the same plural number of lenslet columns so the number of lenslets in lens arrays 403 and 404 is the same. PBS prism bar plate 406 is (similarly analogous to PBS prism bar plate 106) a one-dimensional array of PBS prism bars. The number of PBS prism bars in prism bar plate 406 is the same as the number of rows of lenslets in lens array 403 or 404.

Light source 401 has a light-source area from which unpolarized (or randomly polarized) light is provided. Light pipe 420 has (a) a light-entrance area 421 situated next to the light-source area of light source 401 and (b) a light-exit area 422 facing collimating lens 402. Unpolarized light provided from light source 401 generally across its light-source area enters light pipe 420 at light-entrance area 421, passes largely through pipe 420, and exits pipe 420 across largely all of light-exit area 422 propagating toward collimating lens 402.

Light pipe 420 has four lateral sides, an entrance side that presents light-entrance area 421, and an exit side that presents light-exit area 422. Each lateral side of light pipe 420 is typical largely flat but can be somewhat curved.

An example of light pipe 420 is illustrated in FIG. 5. The entrance side is normally a rectangle having a pair of long edges 423 and a pair of short edges 424. The exit side is likewise normally a rectangle having a pair of long edges 425 and a pair of short edges 426. As a result, light-entrance area 421 and light-exit area 422 are also normally rectangles. The rectangle of either the entrance or exit side can devolve to a square. In that case, edges 423 and 424 of the entrance side are of the same length, or edges 425 and 426 of the exit side are of the same length.

Light pipe 420 is preferably a solid glass bar as represented in the example of FIG. 5. Light-entrance area 421 and light-exit area 422 then respectively equal the areas of the entrance and exit sides of light pipe 420. The exit-side aspect ratio of the length of long edges 425 to the length of short edges 426 normally differs from the entrance-side aspect ratio of the length of long edges 423 to the length of short edges 424.

When light pipe 420 is implemented as a solid glass bar, the entrance side of pipe 420 is provided with an anti-reflective coating (not shown) to inhibit reflection of the unpolarized light from light source 401. The exit side of light pipe 420 is similarly provided with an anti-reflective coating (likewise not shown) to inhibit reflection of the light traveling toward collimating lens 402.

Alternatively, light pipe 420 can be a hollow body with four lateral glass walls. The entrance and exit ends of the hollow body are open. When light-entrance area 421 and light-exit area 422 of the hollow body are rectangles, the exit-side aspect ratio of the length of the long edges of light-exit area 422 to the length of the short edges of light-exit area 422 normally differs from the entrance-side aspect ratio of the length of the long edges of light-entrance area 421 to the length of the short edges of light-entrance area 421.

Whether implemented as a solid glass bar or a hollow body with four lateral glass walls and open entrance/exit ends, light pipe 420 is normally tapered. Light is substantially inhibited from leaving light pipe 420 through its four lateral sides due to internal reflection at the glass-air interfaces of the lateral sides.

The size of light-entrance area 421 of light pipe 420 preferably substantially fully encompasses the size of the light-source area of light source 401 without exceeding the size of the light-source area by any amount more than that needed to accommodate a predetermined shape, e.g., rectangular, for light-entrance area 421. Consider the situation in which light pipe 420 is a solid glass bar and in which light-entrance area 421 is a rectangle formed by the entrance side of light pipe 421. The light-source area is typically shaped as a rectangle. The length of long light-pipe entrance edges 423 then preferably substantially equals the length of the long edges of the light-source rectangle while the length of short light-pipe entrance edges 424 preferably substantially equals the length of the short edges of the light-source rectangle. The rectangular shape of the light-source area can devolve to a square. In that case, the lengths of light-pipe edges 423 and 424 are substantially the same and are substantially equal to the length of each edge of the square.

If the light-source area is shaped as an ellipse, the length of long light-pipe edges 423 preferably substantially equals the length of the long axis of the ellipse while the length of short light-pipe edges 424 preferably substantially equals the length of the short axis of the ellipse. The elliptical shape of the light-source area can devolve to a circle (as represented in FIG. 1 for the light-source area of light source 101). In that case, the lengths of light-pipe edges 423 and 424 are substantially the same and are substantially equal to the diameter of the circle. The foregoing comments about rectangular (including square) and elliptical (including circular) shapes apply to the situation in which light pipe 420 is a hollow body with four lateral glass walls and a rectangular shape for light-entrance area 421 except that the lengths of long light-pipe edge 423 and short light-pipe edge 424 are respectively replaced with the lengths of the long and short edges of light-entrance area 421.

Similar to what happens to the unpolarized light emitted from light source 101 in the conventional illumination system of FIG. 1, unpolarized light which is provided by light source 401 and which passes through light pipe 420 is collimated by collimating lens 402 to form a beam of unpolarized collimated light propagating generally parallel to optical axis 410. The unpolarized light of the collimated beam passes through the plano-convex lenslets of first lens array 403 to form a plurality of initial convergent partial light fluxes (or sub-beams) 411i traveling generally parallel to optical axis 410.

Each initial partial flux 411i consists of the light which passed through a corresponding different one of the lenslets of lens array 403. As viewed along optical axis 410, i.e., in a plane perpendicular to axis 410, light fluxes 411i are thereby distributed in rows and columns respectively corresponding to the rows and columns of lens array 403. The total number of light fluxes 411i equals the number of lenslets in lens array 403 or 404. Partial light fluxes 411i pass respectively through the plano-convex lenslets of second lens array 404 and then respectively through openings in strip-mask plate 405. Strip-mask plate 405 blocks the transmission of extraneous (unwanted) light other than light that passed through the light-pipe structure formed with light pipe 420.

Light fluxes 411i in each light-flux row impinge on a corresponding different one of the PBS prism bars in PBS prism bar plate 406. Each PBS prism boar of prism bar plate 406 splits each of partial light fluxes 411i incident on that PBS prism bar into a linearly polarized component of p linear polarization type and a linearly polarized component of s linear polarization type opposite to p linear polarization type. Light of the p linearly polarized component of each incident partial flux 411i is transmitted through its PBS prism bar to produce a divergent linearly polarized partial flux 412i of p linear polarization type. As viewed along optical axis 410, i.e., in a plane perpendicular to axis 410, directly passed p polarized light fluxes 412i are distributed in rows and columns respectively corresponding to the rows and columns of initial light fluxes 411i and thus respectively corresponding to the rows and columns of lens array 403 or 404.

Light of the s linearly polarized component of each incident partial flux 411i goes through two reflections in its PBS prism bar of PBS prism bar plate 406. The first reflection is by approximately 90°. The second reflection is likewise by approximately by 90° so that light of the s linearly polarized component of each incident partial flux 411i now propagates forward generally along optical axis 410. Light of the s linearly polarized components of partial fluxes 411i passes through the half-wave strips of half-wave strip plate 407. This causes the s linearly polarized components of partial fluxes 411i to be respectively converted into divergent linearly polarized partial fluxes 413i of p linear polarization type. As viewed along optical axis 410, i.e., in a plane perpendicular to axis 410, converted p polarized light fluxes 413i are likewise distributed in rows and columns respectively corresponding to the rows and columns of initial light fluxes 411i and thereby respectively corresponding to the rows and columns of lens array 403 or 404.

Directly passed p polarized partial fluxes 412i and converted p polarized partial fluxes 413i propagate forward generally parallel to optical axis 410 and thus in generally the same direction. As a consequence, each directly passed p polarized partial flux 412i and converted p polarized partial flux 413l that underwent double reflection in the PBS prism bar plate which transmitted that directly passed p polarized partial flux 412i form a partial flux 412i/413i of linearly polarized light of p linear polarization type. Since the number of initial partial light fluxes 411i equals the number of lenslets in lens array 403, the number of partial fluxes 412i/413i of p linearly polarized light equals the number of lenslets in lens array 403.

Focusing lens 408 focuses p partial light fluxes 412i/413i, i.e., directly passed p polarized partial fluxes 412i and converted p polarized partial fluxes 413i, onto the target location formed by panel 109 so that each p partial flux 412i/413i of linearly polarized light is distributed across the panel target location. P partial light fluxes 412i/413i thereby mix across panel 409 so as to become integrated.

The polarization-recovery light integrator formed with components 402-408 is characterized by a light-transmission aperture represented by the aperture at the exit surface of PBS prism bar plate 406. Referring back to FIG. 3, directly passed partial fluxes 412i produce light spots 301i, indicated in solid line, as images of light-exit area 422 of light pipe 420. Converted p polarized partial fluxes 413i produce light spots 302i, indicated in dotted line, as images of light-exit area 422.

The shape and size of light-exit area 422 of light pipe 401 are generally selected so that the integrator aperture is virtually fully filled by directly passed light spots 301i and converted light spots 302i as shown in FIG. 3. By so selecting the shape and size of light-exit area 422, the intensity of partial fluxes 412i and 413i is highly uniform at the flux-mixing target location of panel 409. When the lenslets of lens arrays 403 and 404 are of rectangular shape, light-exit area 422 is preferably shaped as a rectangle having twice the long-edge-to-short-edge aspect ratio of the lenslets. In the case where the long-edge-to-short-edge aspect ratio of the lenslets is 4:3 and where light pipe 420 is a solid glass bar, the ratio of the lengths of long light-pipe exit edges 425 to short light-pipe exit edges 426 is thus preferably 8:3 or 6:4 depending on orientation of PBS prism bar plate 406 to light pipe 420.

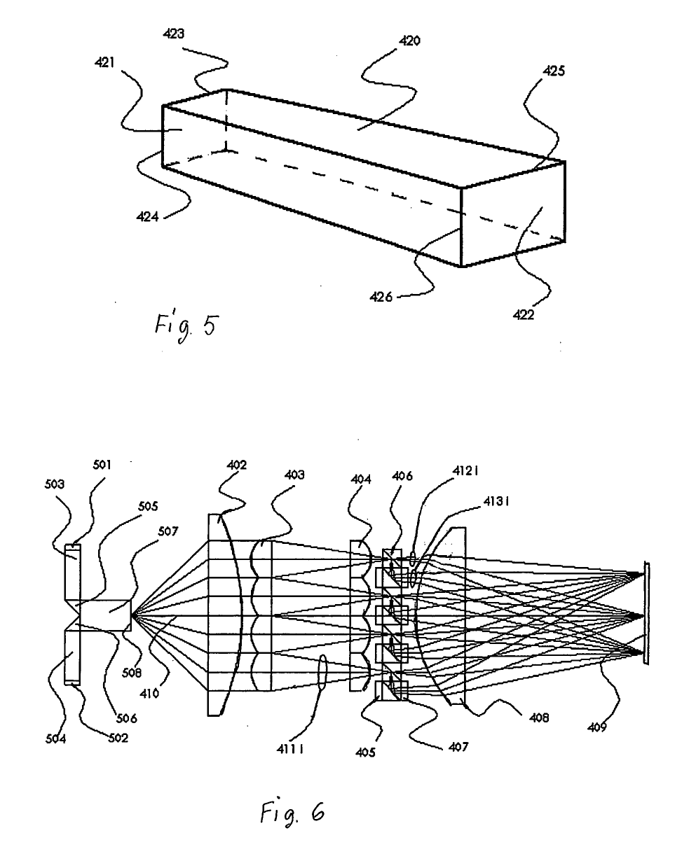

The strategy of using a light-pipe structure to increase the illumination efficiency works with multiple light sources. FIG. 6 illustrates such a lens array polarization-recovery illumination system configured in accordance with the invention. The illumination system in FIG. 6 consists of (a) a light-source structure formed with a first light source 501 and a second light source 502, (b) a light-pipe structure, (c) a light collimator formed with collimating lens 402, and (d) a polarization-recovery light integrator formed with components 403-408. Components 402-408 in the illumination system of FIG. 6 are configured, arranged, and operable the same as in the illumination system of FIG. 4. Light sources 501 and 502 provide unpolarized light from respective first and second light source areas whose combination constitutes the light-source area for the light-source structure.

The light-pipe structure in the illumination system of FIG. 6 is formed with an input light-pipe section and an output light-pipe section. The input section consists of a first input light pipe 503 and a second input light pipe 504. The output section consists of a first prism light reflector 505, a second prism light reflector 506, and an output light pipe 507 having a light-exit area 508. Each of light pipes 503, 504, and 507 preferably consists of a glass bar configured similar to light pipe 420 except that light pipes 503 and 504 may be straight or tapered. Alternatively, one or more of pipes 503, 504, and 507 may be a hollow body with four lateral glass walls and open entrance/exit ends.

Unpolarized light provided from light source 501 generally across its light-source area passes largely through first input light pipe 503, is reflected approximately 90° by first light reflector 503, passes through output light pipe 507, and exits output pipe 507 across at least part of light-exit area 508. Unpolarized light provided from light source 502 generally across its light-source area similarly passes largely through second input light pipe 504, is reflected approximately 90° by second light reflector 506, passes through output light pipe 507, and exits output pipe 507 across at least part of light-exit area 508 such that the combination of light provided by light sources 501 and 502 is distributed across all of light-exit area 508. Consequently, output light pipe 507 combines the light provided from light sources 501 and 502. The unpolarized light exiting output pipe 507 is thereafter provided to collimating lens 402 and processed in the polarization-recovery light integrator in the same manner as in the illumination system of FIG. 4.

The shape and size of light-exit area 508 of output light pipe 507 are preferably selected so that the characteristic aperture of the polarization-recovery light integrator in the illumination system of FIG. 6 is virtually fully filled by directly passed light spots 301i and converted light spots 302i as shown in FIG. 3. Selecting the shape and size of light-exit area 508 in this way enables the intensity of p partial light fluxes 412i/413l, again directly passed partial fluxes 412i and converted partial fluxes 413i, to be highly uniform at the flux-mixing target location of panel 409. When the lenslets of lens arrays 403 and 404 are of rectangular shape, light-exit area 508 is preferably shaped as a rectangle having twice the long-edge-to-short-edge aspect ratio of the lenslets as in the case of single light source 401 in the illumination system of FIG. 4. Also as in the illumination system of FIG. 4, the height of image light spots 301i and 302i in the illumination system of FIG. 6 is then approximately half the lenslet height.

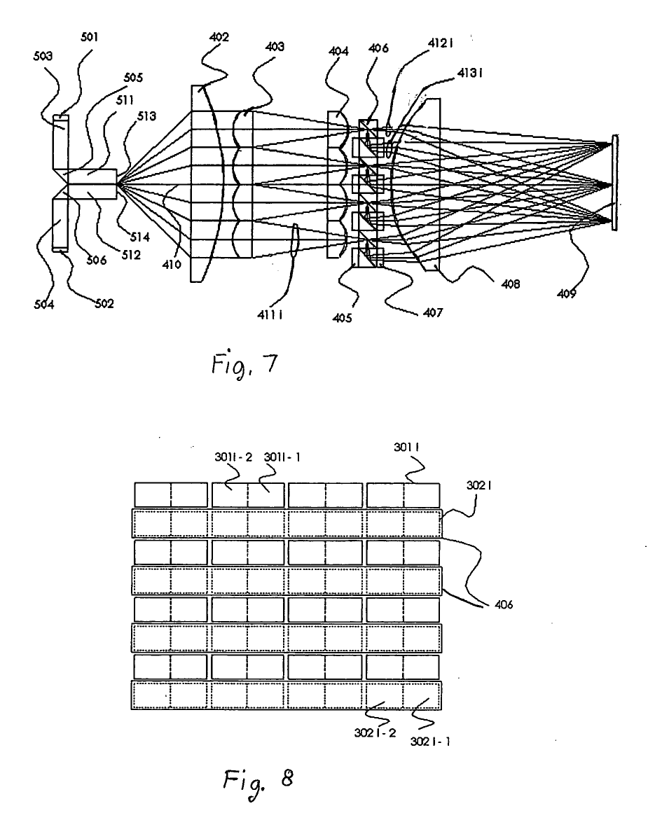

FIG. 7 illustrates a variation, in accordance with the invention, of the double-light-source lens array polarization-recovery illumination system of FIG. 7 in which output light pipe 507 in the output section of the light-pipe structure is replaced with a first output light pipe 511 and a second output light pipe 512. Output light pipes 511 and 512 have respective light-exit areas 513 and 514 whose combination constitutes the light-exit area of the light-pipe structure. Each of light pipes 511 and 512 preferably consists of a solid glass bar configured similar to light pipe 420. Alternatively, one or more of pipes 511 and 512 may be a hollow body with four lateral glass walls and open entrance/exit ends. The remainder of the illumination system of FIG. 7 is configured, arranged, and operable the same as in the illumination system of FIG. 6.

In the illumination system of FIG. 7, unpolarized light provided from first light source 501 generally across its light-source area passes largely through first input light pipe 503, is reflected approximately 90° by first light reflector 503, passes through first output light pipe 511, and exits first output pipe 511 across largely all of light-exit area 513 of output pipe 511. Unpolarized light provided from second light source 502 generally across its light-source area passes largely through second input light pipe.504, is reflected approximately 90° by second light reflector 506, passes through second output light pipe 512, and exits second output pipe 512 across largely all of light-exit area 514 of output pipe 512. The unpolarized light exiting output pipes 511 and 512 is thereafter provided to collimating lens 402 and processed in the polarization-recovery light integrator in the same manner as in the illumination system of FIG. 4.

Output light pipes 511 and 512 do not actually combine the light passing through them. However, output pipes 511 and 512 are preferably so close together that the light passing through them is effectively combined. Also, when output light pipes 511 and 512 consist of largely adjoining glass bars, there is essentially no space between their light-exit areas 513 and 514. Hence, the light exiting second output pipe 512 substantially “adjoins” the light exiting first output pipe 511 so that the exiting light substantially forms a single light beam.

The shapes and sizes of light-exit areas 513 and 514 of output light pipes 511 and 512 are preferably selected so that the characteristic aperture of the polarization-recovery light integrator in the illumination system of FIG. 7 is virtually fully filled by directly passed light spots 301i and converted light spots 302i. This enables the intensity of partial fluxes 412i and 413i to be highly uniform at the flux-mixing target location of panel 409. When the lenslets of lens arrays 403 and 404 are of rectangular shape, the height of image light spots 301i and 302i is again preferably approximately half the lenslet height. This is achieved by configuring each of light-exit areas 513 and 514 as a rectangle having the same long-edge-to-short-edge aspect ratio as the lenslets.

FIG. 8 shows a typical example of the distribution of light spots across the exit aperture of PBS prism bar plate 406 in the illumination system of FIG. 7. The distribution is substantially the same as that shown in FIG. 3. Each light spot 301i for a directly passed light flux 412i consists of (a) a right-hand portion 301i-1 that constitutes an image of light-exit area 513 of first output light pipe 511 and (b) a left-hand portion 301i-2 that constitutes an image of light-exit area 514 of second output light pipe 512. Each light spot 302i for a converted light flux 413i similarly consists of (a) a right-hand portion 302i-1 that constitutes an image of light-exit area 513 of first output pipe 511 and (b) a left-hand portion 302i-2 that constitutes an image of light-exit area 514 of second output pipe 512.

While the invention has been described with reference to preferred embodiments, this description is solely for the purpose of illustration and is not to be construed as limiting the scope of the invention claimed below. For instance, light pipes 420, 503, 504, 507, 511, and 512 can be recycling light pipes to further increase the illumination efficiency. The light-source structure can be implemented with more than two light sources.

A half-wave retardation plate or a plate of half-wave retardation strips can be placed in the optical path (at various locations) so that the directly passed partial fluxes 412i and converted partial fluxes 413i are s linearly polarized. The light-source and light-pipe structures in the illumination system of FIG. 6 or 7 can be rotated 90° about optical axis 410 relative to the remainder of the illumination system. Various changes and applications may thus be made without departing from the true scope of the invention as defined in the appended claims.

We claim:

1. An illumination system comprising:
a light-source structure for providing light across a light-source area;
a light-pipe structure having a light-entrance area and a light-exit area, light provided from the light-source structure generally across its light-source area entering the light-pipe structure at its light-entrance area, passing largely through the light-pipe structure, and exiting the light-pipe structure across largely all of its light-exit area; and
a polarization-recovery light integrator for splitting light which exited the light-pipe structure across its light-exit area into multiple initial partial light fluxes, for converting orthogonally linearly polarized components of the initial light fluxes into multiple partial fluxes of linearly polarized light of substantially only a single linear polarization type, and for mixing the fluxes of linearly polarized light to integrate them.

2. An illumination system as in claim 1 wherein the light-source structure comprises at least one light source.

3. An illumination system as in claim 1 wherein the light-pipe structure comprises at least one light pipe.

4. An illumination system as in claim 1 wherein:
light can travel through a light-transmission area, referred to as an aperture, of the polarization-recovery light integrator;
each flux of linearly polarized light passes through a portion, referred to as a light spot, of the aperture; and
each light spot is largely an image of the light-exit area of the light-pipe structure.

5. An illumination system as in claim 4 wherein the light spots occupy most of the aperture.

6. An illumination system as in claim 4 wherein:
the light-exit area of the light-pipe structure is approximately of a selected rectangular shape; and
each light spot is largely of the selected rectangular shape.

7. An illumination system as in claim 4 wherein the light-source area of the light-source structure is of a materially different shape than the light-exit area of the light-pipe structure.

8. An illumination system as in claim 1 further including a collimator for collimating light exiting the light-pipe structure across the light-exit area into a beam of collimated light, the polarization-recovery light integrator splitting collimated light provided from the collimator into the initial light fluxes.

9. An illumination system as in claim 1 wherein the polarization-recovery light integrator comprises:
a first lens array for splitting light which exited the light-pipe structure across its light-exit area into the initial light fluxes of which there are a selected plurality;
a second lens array for imaging the initial light fluxes on respective image locations;
a polarization beam splitter (“PBS”) prism bar plate situated close to the image locations for splitting the initial light fluxes into a like plurality of respective primary light fluxes of a first linear polarization type and a like plurality of respective light fluxes of a second linear polarization type opposite to the first linear polarization type, light of the primary light fluxes of the first linear polarization type passing through the PBS prism bar plate; and
a half-wave retardation strip plate for receiving the light fluxes of the second linear polarization type after they have been directed thereto by the PBS prism bar plate and for converting them into a like plurality of respective further light fluxes of the second linear polarization type propagating in generally the same direction as the primary light fluxes of the first polarization type whereby the primary and further light fluxes of the first polarization type largely form the aforementioned fluxes of linearly polarized light.

10. An illumination system as in claim 9 wherein the PBS prism bar plate directs the light fluxes of the second linear polarization type to the half-wave retardation strip plate by double reflection.

11. An illumination system as in claim 9 further including a focusing lens for directing the fluxes of linearly polarized light toward a target location so that they mix with one another.

12. An illumination system as in claim 9 wherein:
the PBS prism bar plate comprises a like plurality of beam-splitting elements and has a light-transmission area, referred to as an aperture, through which the primary light fluxes of the first linear polarization type respectively pass through the beam-splitting elements and through which the further light fluxes of the second polarization type are directed to the sides of the beam-splitting elements;
each flux of linearly polarized light passes through a portion, referred to as a light spot, of the aperture; and
each light spot is largely an image of the light-exit area of the light-pipe structure.

13. An illumination system as in claim 12 wherein the light spots occupy most of the aperture.

14. An illumination system as in claim 9 further including a collimator for collimating light exiting the light-pipe structure across the light-exit area into a beam of collimated light, the polarization-recovery light integrator splitting collimated light provided from the collimator into the initial light fluxes.

15. An illumination system as in claim 1 wherein:
only a single light source is present in the light-source structure such that its light-source area is substantially a single continuous area; and
only a single light pipe is present in the light-pipe structure.

16. An illumination system as in claim 15 wherein the light-entrance and light exit areas of the light pipe are both rectangular at different length-to-width ratios such that the light pipe is tapered.

17. An illumination system as in claim 1 wherein:
the light-source structure comprises a plurality of light sources;
the light-pipe structure comprises an input light-pipe section and an output light-pipe section;
the input light-pipe section comprises a like plurality of input light pipes, each input light pipe directing light from a different one of the light sources to the output light-pipe section; and
the output light-pipe section combines light from the input light pipes to produce the light exiting the light-pipe structure.

18. An illumination system as in claim 17 wherein the output light-pipe section comprises at least one output light pipe and at least one light reflector which direct light to the at least one output light pipe.

19. An illumination method comprising:
providing light across a light-source area;
causing light provided across the light-source area to enter a light-pipe structure at a light-entrance area, pass largely through the light-pipe structure, and exit the light-pipe structure across largely all of a light-exit area; and
splitting light which exited the light-pipe structure across its light-exit area into multiple initial partial light fluxes;
converting orthogonally linearly polarized components of the initial light fluxes into multiple partial fluxes of linearly polarized light of substantially only a single linear polarization type; and
mixing the fluxes of linearly polarized light to integrate them.

20. An illumination system as in claim 19 wherein:
light travels through a light-transmission area, referred to as an aperture, during the converting act;
each flux of linearly polarized light passes through a portion, referred to as a light spot, of the aperture; and
each light spot is largely an image of the light-exit area of the light-pipe structure.

21. An illumination system as in claim 20 wherein the light spots occupy most of the aperture.

22. An illumination method as in claim 19 wherein:
the method further includes collimating light exiting the light-pipe structure across the light-exit area into a beam of collimated light; and
the splitting act comprises splitting so-collimated light into the initial light fluxes.
